(19) United States
(12) Patent Application Publication
(10) Pub. No.: US 2002/0174504 A1
(43) Pub. Date: Nov. 28, 2002

(54) Adapter for windshield wiper arms

(75) Inventor: In-Kyu Kim, Ansan-shi (KR)

Correspondence Address: STAAS & HALSEY LLP, 700 11TH STREET, NW, SUITE 500, WASHINGTON, DC, 20001, US

(73) Assignee: ADM 21 CO., LTD, Ansan-shi (KR)

(21) Appl. No.: 09/861,652

(22) Filed: May 22, 2001

(51) Int. Cl. B60S 1/40

(52) U.S. Cl. 15/250.32

(57) ABSTRACT

An adapter for windshield wiper arms which is used to couple a wiper arm to a wiper blade is provided. The adapter is capable of accommodating a variety of wiper arm types known as the hook, bayonet and pin type wiper arms, and even the different size hook type wiper arms. Further, the adapter has vertical wings with protrusions formed at outer surfaces thereof so as to thereby reduce a friction caused between the adapter and the adapter accommodating portion of the wiper blade, and a plurality of embossings formed at inner walls of vertical wings so as to thereby prevent the hook type wiper arm from vibrating.

### FIELD OF THE INVENTION

The present invention relates to an adapter used to couple a wiper arm to a wiper blade, and more particularly, to an adapter capable of accommodating a variety of wiper arm types known as the hook, bayonet and pin type wiper arms, and even the different size hook type wiper arms. Further, an adapter of the present invention has vertical wings with protrusions formed at outer surfaces thereof so as to thereby reduce a friction caused between the adapter and the adapter accommodating portion of the wiper blade.

### BACKGROUND OF THE INVENTION

Korean Utility Laid Open No. 91-7131 discloses an adapter for vehicle wiper supports, which is described with reference to FIGS. 1 and 2 as follows. An adapter(110) has a bayonet type wiper arm(B) accommodation portion formed by a cover with a coupling hole 114 for insertion of a protrusion 1 formed at the bayonet type arm(B) and an insertion hole 112; a hook type wiper arm(H) accommodation portion formed by a first stopper 126 and a second stopper 128 protruded from an inner upper surface and an inner front surface of a vertical wing 122; and a pin type wiper arm(P) stopper recess 132 formed behind a pivot insertion groove 134 formed at the bottom surface of the adapter.

However, the above-described adapter has disadvantages in terms of production and purchase of products since the adapter is not capable of accommodating different size hook type arms. Further, frictions are caused between the inner wall of an adapter accommodation portion 142 of a wiper blade 140 and the outer wall of the vertical wing of the adapter prevent smooth operation.

### SUMMARY OF THE INVENTION

Therefore, it is an object of the present invention to provide an adapter which is capable of accommodating a hook type, a bayonet type, and a pin type wiper arm, respectively. It is another object of the present invention to provide an adapter which is capable of accommodating different size hook type wiper arms. It is still another object of the present invention to provide an adapter with a vertical wing capable of reducing frictions between the adapter and a wiper blade.

When the adapter with such improvements is used, an incorporation of the wiper blade in combination with the arm is obtained through the adapter, and a smooth power transmission is achieved, to thereby improve the wiping performance of the wiper and at the same time lengthen operational lifetime of the wiper.

### DESCRIPTION OF THE DRAWINGS

FIG. 1 is a perspective view of a conventional adapter;

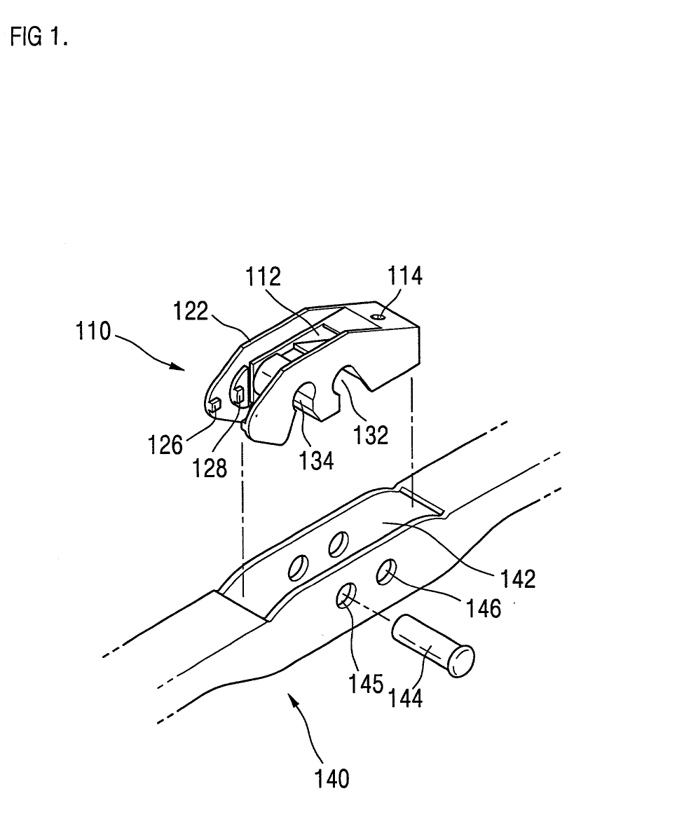

FIGS. 2A, 2B and 2C are perspective views of a bayonet type, a hook type and a pin type wiper arm, respectively;

FIGS. 3A, 3B, 3C and 3D are perspective view, sectional view, front view and plane view of an adapter, respectively, according to the present invention;

FIGS. 4A and 4B are sectional views illustrating a coupled state between an adapter and hook type wiper arms with different size, according to the present invention;

FIG. 5 is a sectional view illustrating a coupled state between an adapter and a bayonet type wiper arm, according to the present invention; and

FIGS. 6A and 6B are perspective views illustrating an adapter and a pin type wiper arm when attached/detached to/from each other, according to the present invention.

### DETAILED DESCRIPTION OF THE PRESENT INVENTION

Now, the present invention will be explained in more detail with reference to the attached drawings. Throughout the drawings and specifications, identical elements bear identical reference numerals and the description thereof will be omitted.

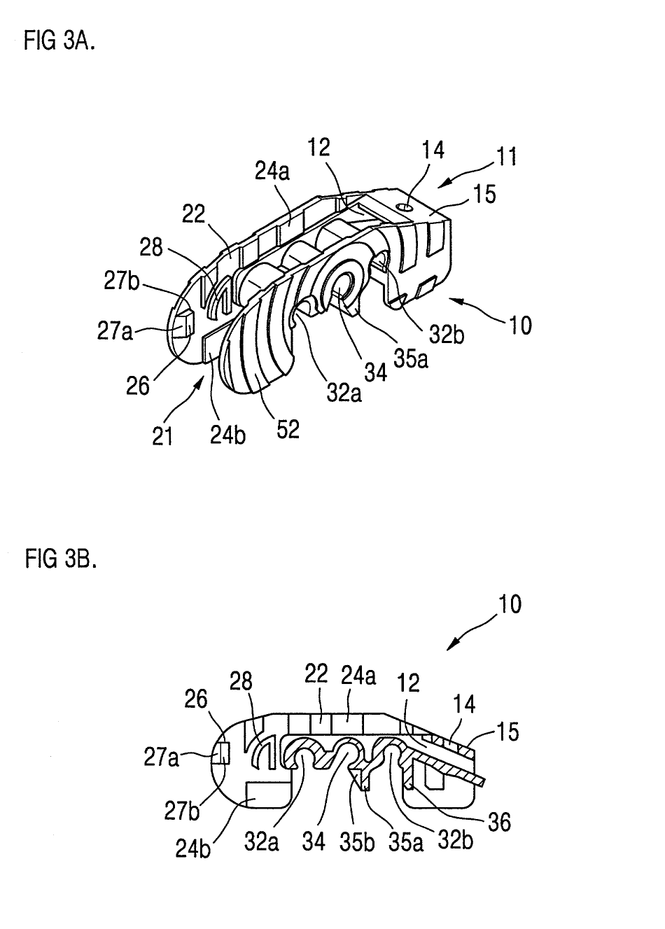

Referring to FIGS. 3A to 3D, an arm adapter 10 for a wiper blade according to an embodiment of the present invention includes at a bottom surface thereof a pivot insertion groove 34 to be coupled to a wiper blade 40 through a pivot 44, and a pin stopper recess 32 for a pin type wiper arm(P); a hook type wiper arm(H) accommodation portion 21 formed by an inner front surface and an upper surface surrounded by vertical wings 22 with a first stopper 26 and a second stopper 27 protruded, with a predetermined spacing, from the front inner side walls of vertical wings; and a bayonet type wiper arm(B) accommodation portion 11 formed, at a rear inner surface of the arm adapter, by an inclined accommodation opening 12 and a cover 15 having a coupling hole 14 penetrated at the center of the cover. The adapter 10 with the pin stopper recess 32, the hook type wiper arm accommodation portion 21 and the bayonet type wiper arm accommodation portion 11 which are formed integrally with the adapter, is assembled into an adapter insertion opening 42 of the wiper blade 40, and a wiper arm as a power transmission body is coupled to the assembly. The vertical wings 22 has at inner surfaces thereof a plurality of embossings 24a and 24b, and the first stopper 26 and the second stopper 28 have front inclined surfaces 27a and 29a and rear stoppers 27b and 29b formed integrally with each other, to thereby form the hook type wiper arm accommodation portion 21. The vertical wings 22 have at outer surfaces thereof a plurality of C-shaped protrusions 52.

An arm adapter 10 according to another embodiment of the present invention has the hook type wiper arm(H) accommodation portion 21 with embossings 24a and 24b, the embossing 24a formed in front of the embossing 24b being projected farther than the embossing 24b, the second stopper 28 being projected farther than the first stopper 26, thus allowing different size hook type wiper arms H1 and H2 to be accommodated through a first protruded piece 35 formed at the rear surface of the pivot insertion groove 34 and a second protruded piece 36 formed at the rear surface of the pin stopper recess 32.

The adapter of the present invention operates as follows.

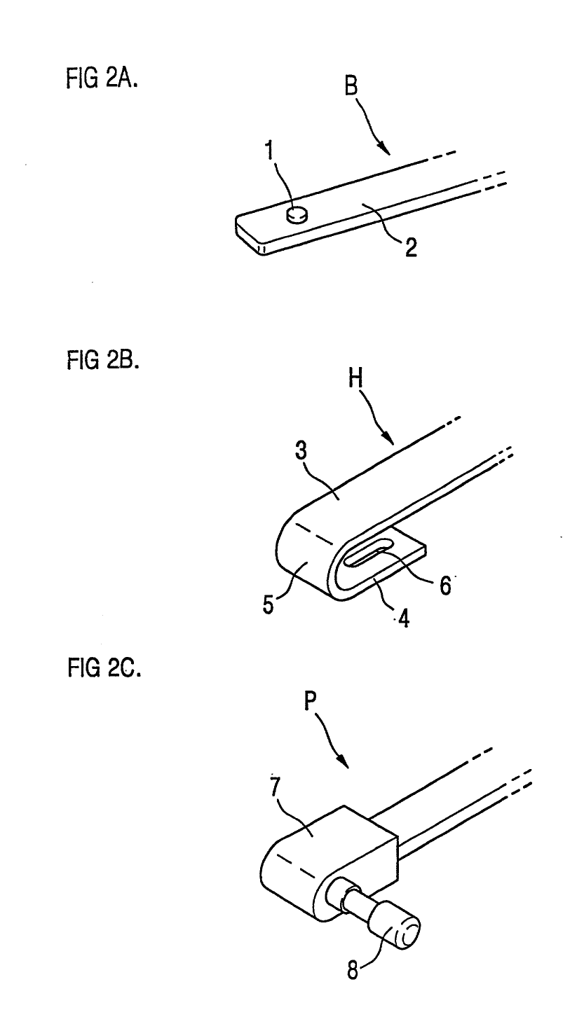

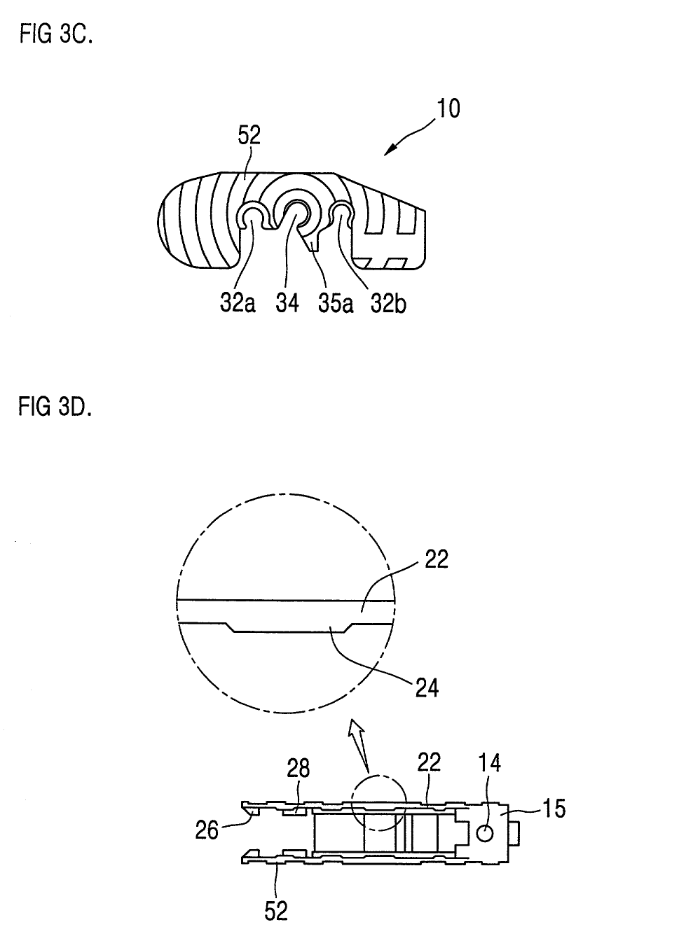

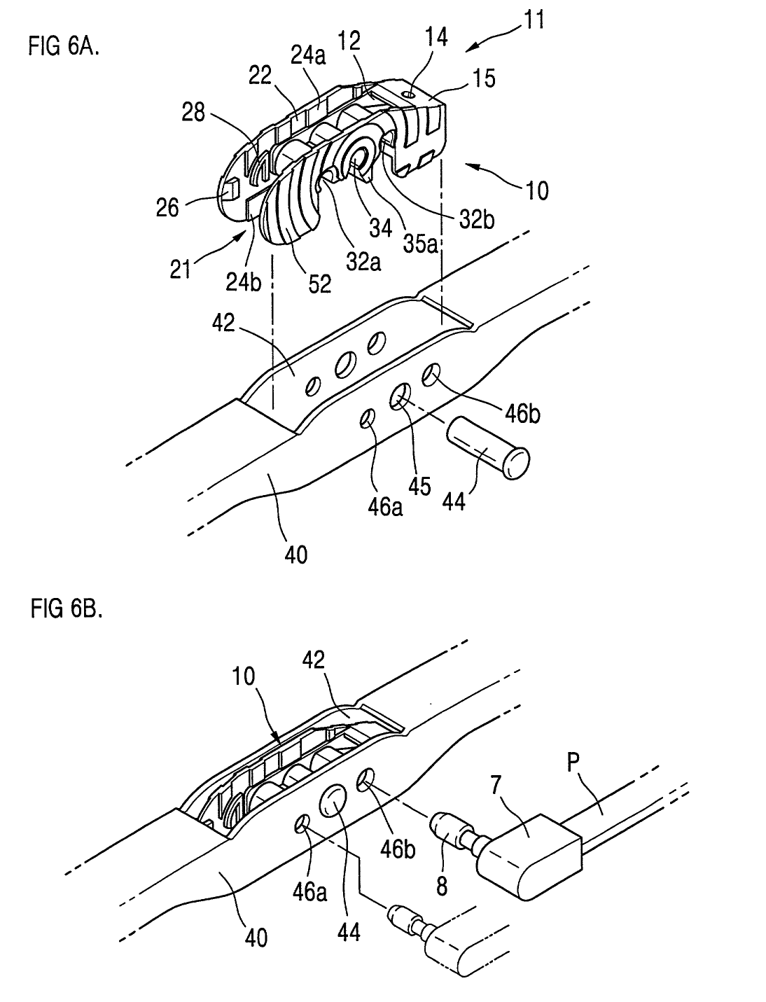

Referring to FIGS. 2B, 4A and 6A, the case where the hook type wiper arm H1 having a relatively larger spacing and width between an upper line portion 3 and a lower line portion 4 with a curvature 5 interposed between the upper line portion and the lower line portion is connected to the wiper blade 40, will be explained. In such cases, the hook type wiper arm H1 is inserted into the hook type wiper arm accommodation portion. That is, the curvature 5 of the arm H1 slides through the front inclined surface 27a of the first stopper, toward inside of a stopper 27b when pushed from the front of the adapter. Subsequently, when the upper line portion 3 of the arm H1 is pressed downwardly and thus the embossing 24a of the vertical wing is pushed, the front portion of the vertical wing is widened due to the elasticity and the wiper arm H1 contacts the upper surface of the adapter. At this time, an end of the upper surface of the lower line portion 4 of the arm H1 contacts the second protruded piece 36, and a slot 6 formed at the arm H1 is coupled to the first protruded piece 35, to thereby achieve a firm fixation of the arm H1. Subsequently, the arm H1 is accommodated into the adapter insertion opening 42 of the wiper blade 40, and a pivot insertion hole 45 of the blade and the pivot insertion groove 34 are connected through the pivot 44, as shown in FIG. 6A. When the windshield wiper is in operation, the arm H1 may not escape from the space formed among the first stopper 26, the stopper 27b and the second stopper 28, and is elastically supported by the embossing 24a, a stabilized operation of the wiper without vibration can be obtained. As a consequence, an improved transmission of the power is achieved while lengthening useful life of the product as a whole.

Referring to FIGS. 2B, 4B and 6A, the case where the hook type wiper arm H2 having a relatively narrower spacing and width between an upper line portion 3 and a lower line portion 4 with the curvature 5 interposed between the upper line portion and the lower line portion is connected to the wiper blade 40, will be explained. The curvature 5 of the arm H2 slides through the inclined surface 29a of the second stopper 28, toward inside of a stopper 29b when pushed from the front of the adapter. Subsequently, when the upper line portion 3 of the arm H2 is pressed downwardly and thus embossings 24a and 24b of the vertical wing 22 is pushed, the wiper arm H2 contacts the upper surface of the adapter. At this time, an end of the lower line portion 4 of the arm H2 contacts the second protruded piece 36, and the slot 6 formed at the arm H2 is coupled to the first protruded piece 35, to thereby achieve a firm fixation of the arm H2. Then, the arm is coupled to the wiper blade in the same manner as for the arm H1 discussed above. When the windshield wiper is in operation, the arm H2 may not escape from the space formed among the second stopper 28, the stopper 29b and the main body of the adapter, and is elastically supported by the embossing 24b, a stabilized operation of the wiper without vibration can be obtained.

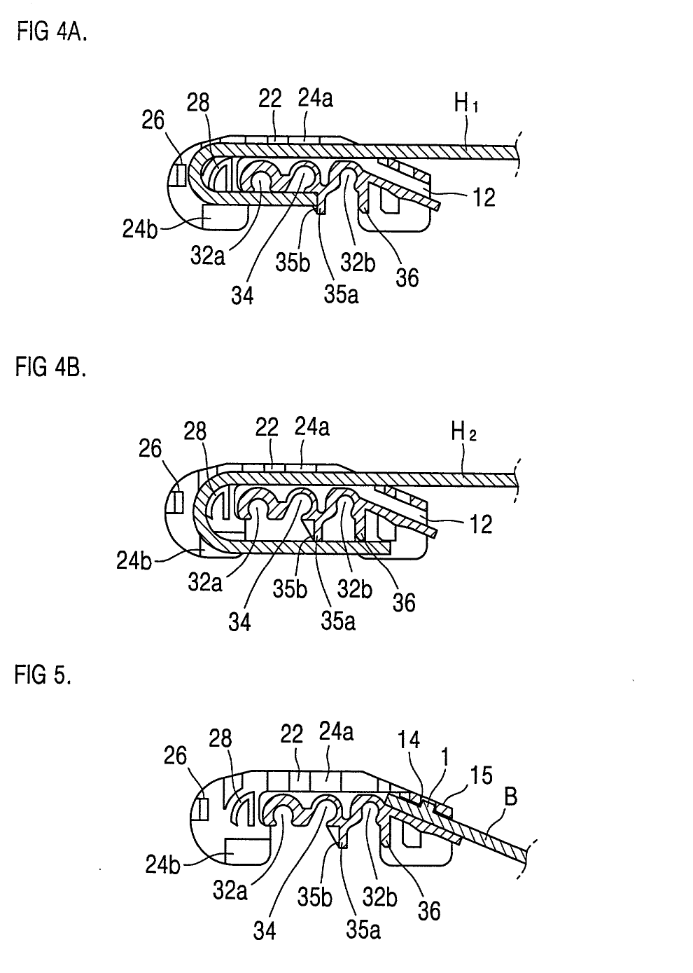

Referring to FIGS. 2A and 5, the case where the bayonet type wiper arm(B) is connected to the wiper 40 will be described. In this case, the wiper arm(B) is inserted to the bayonet type wiper arm(B) accommodation portion 11. That is, when the front portion of the arm(B) is pushed from behind the accommodation opening 12, the coupling hole 14 perforated at the center of the cover 15 of the adapter 10 is coupled to the protrusion 1 of the arm(B), to thereby fix the arm(B). The arm(B) is coupled to the wiper blade in the same manner as for arms H1 and H2 discussed above.

Referring to FIGS. 2C, 6A and 6B, the case where the pin type wiper arm(P) is connected to the wiper 40 will be described. As shown in FIG. 6A, the adapter 10 is accommodated into the adapter insertion opening 42 of the wiper blade 40, and the pivot insertion hole 45 of the blade and the pivot insertion groove 34 of the adapter are connected through the pivot 44. Subsequently, as shown in FIG. 6B, a pin insertion hole 46 of the blade 40 and the pin stopper recess 32 of the adapter 10 are coupled through a side locking pin(8) of the pin type wiper arm(P).

As described above, an adapter of the present invention is advantageous in that the adapter accommodates all three styles of hook, pin and bayonet, to thereby eliminate the necessity of manufacturing or purchasing adapters for different shape and size arms, and reduce cost and parts count. In addition, the adapter of the prevent invention has a protrusion formed at the vertical wing so as to decrease the friction caused between the wiper blade and the adapter, thus achieving a smooth rotation of the adapter.

Furthermore, when the adapter of the present invention is employed as a means for coupling arms to a wiper blade, arms are accommodated tightly and integrally into each accommodation portion and groove of the adapter so that the transmission of driving force through arms is improved, to thereby also improve performance and operational lifetime of the wiper.

What is claimed is:

1. In an adapter for windshield wiper arms including a pivot insertion groove to be coupled to a wiper blade through a pivot, and a pin stopper recess for a pin type wiper arm, said pivot insertion groove and said pin stopper recess being formed at the bottom surface of said adapter; a hook type wiper arm accommodation portion formed by an inner front surface and an upper surface surrounded by vertical wings with a first stopper and a second stopper protruded, with a predetermined spacing, from a front inner side walls of vertical wings; and a bayonet type wiper arm accommodation portion formed, at a rear inner surface of the arm adapter, by an inclined accommodation opening and a cover having a coupling hole penetrated at the center of the cover, said adapter being assembled into an adapter insertion opening of said wiper blade, and to a wiper arm as a power transmission body being coupled to an assembly of said adapter and said blade,
an adapter for windshield wiper arms is characterized in that said vertical wings have at inner surfaces thereof a plurality of embossings, and said first stopper and said second stopper have front inclined surfaces and rear stoppers formed integrally with each other, so as to form said hook type wiper arm accommodation portion, and said vertical wings have at outer surfaces thereof a plurality of C-shaped protrusions.

2. An adapter for windshield wiper arms according to claim 1, wherein said hook type wiper arm accommodation portion has a front embossing projected farther than a rear embossing, and said second stopper is projected farther than said first stopper, whereby allowing different size hook type wiper arms to be accommodated through a first protruded piece formed at a rear surface of said pivot insertion groove and a second protruded piece formed at a rear surface of said pin stopper recess.
